(19) United States
(12) Patent Application Publication
(10) Pub. No.: US 2005/0187112 A1
(43) Pub. Date: Aug. 25, 2005

(54) Composition and method for a dual-function soil-grouting excavating or boring fluid

(75) Inventors: K. Gifford Goodhue JR., Spring, TX (US); John M. Wilkerson III, Hixson, TN (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: KB INTERNATIONAL, LLC, CHATTANOOGA, TN (US)

(21) Appl. No.: 11/107,139

(22) Filed: Apr. 15, 2005

Related U.S. Application Data
(63) Continuation-in-part of application No. 09/880,409, filed on Jun. 13, 2001, now Pat. No. 6,897,186.
Application No. 09/880,409 is a continuation-in-part of application No. 09/023,150, filed on Jan. 12, 1998, now Pat. No. 6,248,697.
(60) Provisional application No. 60/037,712, filed on Feb. 12, 1997.

(51) Int. Cl. C09K 7/00

(52) U.S. Cl. 507/117; 507/140

(57) ABSTRACT

Dry flowable solid compositions useful for preparing precision excavation and soil-grouting fluids are disclosed. The compositions are formulated so that, when added to water to form an excavation fluid, they enable the fluid in contact with unstable or sandy soils in the selected areas of the excavation to react and form silicate-based derivatives with lesser solubility and movement, thereby improving soil stability at the excavation wall.

### CROSS-REFERENCE TO RELATED APPLICATIONS

This application is a continuation-in-part of U.S. patent application Ser. No. 09/880,409 filed Jun. 13, 2001, which is a continuation-in-part of U.S. patent application Ser. No. 09/023,150 filed Jan. 12, 1998, now U.S. Pat. No, 6,248,697, which claims benefit of U.S. Provisional Application No. 60/037,712 filed Feb. 12, 1997. The disclosure of each of the aforementioned applications is incorporated herein by reference.

### FIELD OF THE INVENTION

The invention relates to compositions used to produce fluids used in drilling, boring, and excavating operations. More specifically, this invention relates to dry compositions produced to mix with water or water-based earth stabilization and earth support fluids. The compositions are useful in creating boreholes, wells, shafts, tunnels, and other excavations in water-sensitive and water-swellable soils as well as less stable, lower-cohesion soils containing sands, silts, gravels, or cobbles or any combination of these soil materials. The compositions of the invention, when used according to the methods of U.S. Pat. Nos. 5,407,909, 5,663,123, 6,248,697 and this invention, have a unique dual functionality as geotechnical excavating fluids and as earth-grouting or soil hardening compositions.

### BACKGROUND OF THE INVENTION

In earth boring and excavating for wells, deep foundations, tunnels and other geotechnical applications, fluids or muds have been used to hold open and maintain the stability of boreholes and excavations. These fluids or muds have used hydrostatic pressure and controlled interaction with the earth to accomplish their functions. The excavations have been kept full of the fluids or muds during the excavating or boring process, with or without circulation of the fluids.

Conventional bentonite-based excavation fluids are cumbersome to use due to the significant quantity of bentonite required to produce the equivalent amount of excavation fluid as a synthetic polymeric based excavation fluid. Typically it requires 30 to 50 times the quantity of bentonite as synthetic polymer to produce the same volume of excavating fluids. Bentonite-based excavation fluids also require that significant surface equipment be on hand, i.e. a high-speed impeller mix tank, hydrocyclones and shaker screens. Synthetic polymer systems do not require any of these pieces of equipment, thereby reducing the surface equipment footprint as well as the surface plant's complexity. Because bentonite slurry is also considered a hazardous material, it is costly to dispose of and must be disposed of under specific guidelines. Structural load-bearing elements constructed in excavations produced under bentonite slurry have been shown to exhibit inferior perimeter load-bearing capacity to those constructed in excavations produced under synthetic polymeric based slurries.

Conventional synthetic polymer slurries outside the teaching of U.S. Pat. Nos. 5,407,909 and 5,663,123 are composed predominantly of water-solubilized anionic polyacrylamide. These slurry systems rely solely on polymer concentration and viscosity to control the hydration or swelling of water sensitive soils and to control fluid loss into porous formations through a drag effect. These polymer fluids also have very limited capacity to chemically enhance the cohesiveness of low-cohesion soils.

Historically, when either of the above geotechnical fluid technologies was used and soil improvement or improved cohesive values were desired, pre-beneficiation was required to strengthen the soil. This was typically accomplished through a jet grouting process. In many cases alkaline solubilized silicates were applied or injected into the soils either by themselves or followed by an accelerator, such as a soluble aluminate or carbonate, which increased the rate of set of the alkaline soluble silicate. Excavation with the two above mentioned geotechnical fluids was initiated only after completion of this type of pretreatment to increase the cohesive values within a formation. If soil instability was still noted once excavation was initiated, the typical response was to halt excavation and further treat the ground formation using the above process.

In addition, prior geotechnical fluid technologies frequently rely on the user to mix the proper amounts of several required materials (bentonite or polymer as well as other additives) in water to provide a suitable working fluid. The potential for operator error is high, which may result in wasted materials (if an improperly mixed batch of fluid is discarded) or substandard performance (if the operator attempts to use the improperly mixed fluid in excavation). On the other hand, advance preparation and storage of the complete excavation fluid would require excessive storage space and shipping costs. More significantly, certain of the polymer-based excavation fluids can lose effectiveness if the polymer remains in contact with water for too long before use. Accordingly, there exists a significant need for premixed dry compositions that may be added directly to water to provide a suitable excavation fluid. Such premixed compositions can significantly reduce the potential for operator error by providing all of the required components of the system in the correct ratios.

Separately, in processes for improving the cohesion and load-bearing properties of granular or unconsolidated soils and other unstable granular earth formations or materials, reactive compositions have been injected into and mixed with the soils to cause solidification or hardening of the soils. These reactive compositions have included silicates, cementitious grouts and other materials. These soil-improvement materials and techniques have been applied in preparation for excavation, drilling, tunneling, or pile-driving, to render the soils resistant enough to support deep excavations for things such as foundation systems such as bored piles, or to bear the weight of structures erected on pad-type foundations or spread footings. These processes whereby weak soils are prepared to receive excavations for things such as foundation systems or other geoconstruction elements are generally referred to as ground improvement.

In a typical sequence of events for the construction of structures on poor soil, ground improvement techniques are used, followed by excavating or drilling to create deep foundation elements such as diaphragm wall panels, barrettes, or bored piles. Frequently the excavations or borings are made with the help of a fluid or mud as described above. In this two-step process, the weak soil is first strengthened by ground improvement techniques such as reactive silicate injection or mixing; then excavations are created in or through the strengthened soil with the help of an excavating fluid or drilling mud. Finally, reinforced concrete is formed in the excavations in order to create a competent deep construction system.

In the prior art, silicates and silicate-reactive compounds have been injected into or mixed with granular, rubbleized or vugular earth formations, fills or other materials in advance of or during pauses in drilling or excavating, to strengthen or solidify the earth formations. Polymer-based fluids have been used for excavating and drilling, to support the walls of the excavations or wells. Silicates have been added to drilling muds in attempts to prevent heaving of shales. What has been unknown in the prior art is the formulation and effective application of a single fluid which is both and at the same time a drilling mud or earth support fluid and a reactive, soil-permeating, silicate-based chemical-grouting ground-improvement or ground-solidification agent that is effective in the presence of unstable earth environments (e.g. sand). In particular, flowable solid compositions suitable for addition to water to form such dual-purpose fluids have been unknown until now.

### SUMMARY OF THE INVENTION

The invention disclosed herein offers an improvement over prior synthetic polymeric slurry systems such as those described in U.S. Pat. Nos. 5,407,909, 5,663,123, and 6,248,697 in that the present compositions combine several of the key materials in a dry granular, powder, bead, or flake form, or any combination of these forms, into an easily applied product. The compositions of this invention contain polymers or copolymers in combination with granular silicates. The polymers are preferably based on a vinyl backbone but may also include synthetic polymers as well as natural and modified natural polymers, such as cellulosics, reacted or modified cellulosics, starches, reacted or modified starches, polysaccharides, reacted or modified polysaccharides, gums, reacted or modified gums, biopolymers, reacted or modified biopolymers and combinations thereof, as well as blends and grafts of the above. All polymers may range in size or scale from nanopolymers to macropolymers. All polymers and silicates may be hydrophobically modified.

The present composition may also include glass, ceramic or metal oxide beads, bubbles, or spheres, which may be solid, honeycombed, or hollow. The present composition may also include silica dioxides, fumed silica and metal oxides, and other dry silica and metal oxide materials. The fumed silica and metal oxides may range from hydrophilic to hydrophobic in nature. Quantities of naturally occurring silica-containing clays may also be incorporated into the present composition.

Pre-mixing these materials in defined ratios greatly simplifies the application of the technology described in the above patents for the user. More importantly, pre-packaging ensures that the required polymers will be applied to the geotechnical fluid in a correct initial ratio to produce a suitable excavation fluid.

In another aspect, the present disclosure provides a method of making a geotechnical fluid including the step of mixing the aforementioned premixed dry blend with water.

### DESCRIPTION OF THE INVENTION

The invention disclosed herein is a dry, flowable solid composition useful for preparing a dual-purpose excavating and soil-strengthening fluid. The composition contains water-dispersible polymers, alkalis, and optionally silica; metal oxides; glass, ceramic or metal oxide beads, bubbles, or spheres; and/or soil or earth solids. The composition is intended to be mixed with a predetermined amount of water to provide the dual-purpose fluid. The fluid's multi-purpose nature is expressed in its functions as (1) an earth-support fluid as known in the prior art; (2) a soil-strengthening fluid which functions in a manner similar to silicate “chemical grouts” known in the prior art; and (3) a weighting agent to increase the specific gravity of a slurry system. The fluid accomplishes the earth support function (as performed by drilling muds and the like) concurrently and in combination with the chemical grouting or ground improvement function (previously performed by reactive silicate injection and/or soil mixing prior to excavating or boring). Compositions according to the present invention accomplish the above through a dry blend containing (1) polymers and copolymers based on a vinyl backbone; (2) a dry silicate; and optionally one or more of (3) a medium molecular weight polymer and/or an alkali-swellable, water-dispersible polymer; (4) silica and/or metal oxides; (5) glass, ceramic or metal oxide beads, bubbles, or spheres; and (6) naturally occurring silica-containing clays.

At least one of the polymers may be selected from anionic, cationic, ampholytic or nonionic polymers; and they may be non-cross-linked, lightly cross-linked, highly cross-linked, or any combination thereof. Ampholytic for the course of this document shall mean a polymer of material with both anionic and cationic reactivity. These polymers may also have associative properties. Specifically, the polymer contains a number of water insoluble (or low-solubility) groups, or semi-hydrophobic, hydrophobic and/or complex hydrophobic groups or strands that associate in aqueous solution to form a semi-organized to highly organized network of polymer strands. The associations between these hydrophobic moieties may be disrupted with shear or other force without permanent chemical change to the polymer strands or to the hydrophobes. Once shear or other force subsides, the hydrophobes will reorient and re-form unions or weak to strong chemical associations. The hydrophobes may be anionic, nonionic, cationic, or ampholytic. In some instances the associative group may not only be hydrophobic but may be amphiphilic.

The polymer preferably has a nominal average molecular weight (M_{w}) of at least 100,000; more preferably at least 500,000; even more preferably at least 1,000,000 and most preferably 15,000,00 to 20,000,000. It is preferred that the polymer be based on a vinyl backbone.

Suitable anionic polymers may be prepared by the hydrolysis of an acrylamide- and/or acrylonitrile-based monomer during or after the polymerization or from the direct copolymerization of acrylamide with the anionic monomers. Suitable anionic monomers include, without limitation, acrylic acid, methacrylic acid, methacrylic anhydride, maleic acid, maleic anhydride, fumaric acid, fumaric anhydride, itaconic acid, itaconic anhydride, styrene sulfonic acid, vinyl sulphonate, styrene phosphonate, 2-acrylamido-2-methylpropane sulfonic acid (AMPS®), vinyl sulfonic acid, sulfoalkylacrylates, sulfoalkyl acrylamides, allyl sulfonic acid, methallyl sulfonic acid, allyl glycidyl ether sulfonate, vinyl acetic acid, allylacetic acid, 4-methyl-4-pentenoic acid, α-haloacrylic acid, β-hydroxyethyl acrylate, β-carboxyethyl acrylate and water soluble salts thereof, allylic monomers, isopropenyl styrene isocyanate, alpha, alpha-dimethyl-m-isopropenyl benzyl isocyanate CytecTMI®, with or without prereaction with any nonionic surfactant that is amine or hydroxyl terminal, vinyl acetate, methacrylamide, styrene sulfonic acid, 2-acrylamido-2-methylpropane sulfonic acid (AMPS®) and the like, and water soluble salts thereof. Preferred anionic monomers include acrylic acid, methacrylic acid, maleic acid, vinyl or styrene sulfonates, and 2-acrylamido-2-methylpropane sulfonic acid; salts thereof; and combinations thereof. Copolymers of acrylamide or another nonionic monomer with two or more of the foregoing anionic monomers are also within the scope of the invention.

The molar percentage of the comonomers in the polymer may-vary within certain limits, provided that the total adds up to 100%. The anionic charge density in the polymer will vary from about 5% to 90%, preferably 10% to 80%, and most preferably 35% to 65%. The composition, anionicity, and molecular weight of the copolymer may be optimized for the particular earth formation and water conditions in order to achieve the desired drilling, boring, or excavation and earth supporting finctions.

Suitable polymers for compositions according to the invention also include ampholytic copolymers formed by copolymerization of anionic monomers (or their precursors) as described above with certain cationic monomers. Suitable cationic monomers include, without limitation, dimethyl or diethyl aminoethylmethacrylate or dimethyl diethyl aminopropyl(meth)acrylamide, N,N-dimethylamino propylacrylamide, N,N-dimethylamino propylacrylamide, methyl chloride quat, diacetone acrylamide, hydroxy ethyl acrylamide, N,N-dimethyl acrylamide, dimethylaminoethyl acrylate, N-isopropylacrylamide, N-alkylacrylamides, N,N-diethyl acrylamide, dimethyl acrylamide, dimethylamino propylacrylamide, diallyldimethylammonium chloride, quaternized dimethylaminoethyl methacrylates, N,N-dimethylaminopropyl methacrylamide, and combinations thereof. These cationic constituents may be reacted to form acid salts or quaternized using methyl chloride or dimethyl sulfate.

Suitable nonionic monomers for compositions according to the invention include, without limitation, acrylamide, methacrylamide, styrene, C₁ to C₂₀ acrylates, C₁ to C₂₀ methacrylates, N-vinyl pyrrolidone, vinyl acetate, urethane, N-vinyl formamide, N-vinyl acetamide, vinyl acetate acrylonitrile, methylacrylonitrile, isopropenyl styrene isocyanate, acrylamide, methacrylamide, β-hydroxyethyl acrylate, allyl alcohol and allyl chloride, hydroxypropyl methacrylate, hydroxyethyl acrylate, hydroxylethyl methacrylate, 2,3 glycididyl methacrylate, lauryl acrylate, butanediol monoacrylate, 2-hydroxypropyl acrylate, 2-hydroxyethyl acrylate, isobutyl acrylate, 2-ethylhexyl acrylate, tertiarybutyl methacrylates, tertiarybutyl acrylate, decyl methacrylate isomers, lauryl methacrylate, stearyl methacrylates, and any di- or tri-acrylate or methacrylate functional monomers, ethylene, vinyl acetate, C₃ to C₂₀ alpha olefins, 3-butadiene, isoprene and chloroprene and acrylic acid, methacrylic acid, maleic acid and/or maleic anhydride, fumaric anhydride, itaconic anhydride or methacrylic anhydride, isopropenyl styrene isocyanate, with pre-reaction with any nonionic surfactant that is amine or hydroxyl terminal, and mixtures of the foregoing. Especially preferred is acrylamide.

Suitable associative monomers for compositions according to the present invention include, without limitation, alkoxylates including sorbitol, monosaccharide, starch, or polysaccharide, phenol, diphenol, alkyl C₁ to C₂₄ produced using 0 to 100 moles ethylene oxide, propylene oxide, butylene oxide or mixtures and their derivatives with methacrylic anhydride, isopropenyl styrene isocyanate, alpha, alpha-dimethyl-m-isopropenyl benzyl isocyanate (Cytec TMI®), maleic anhydride, itaconic anhydride, fumaric anhydride or their corresponding acids to form bonded reactive monomer-surfactant combinations, and mixtures of the foregoing.

Suitable copolymers for compositions of the present invention may also incorporate small amounts of water insoluble/hydrophobic monomers such as C₅ to C₂₄ long chain alkylates, hydroxyalkylates, and N-alkyl substituted acrylamides, C₃ to C₂₄ alpha olefins, or other hydrophobically oriented monomers or copolymerizable surfactants prepared from monomer acids, anhydrides, and (Cytec TMI®) alpha, alpha-dimethyl-m-isopropenyl benzyl isocyanate with any nonionic surfactant or block copolymers and combinations thereof. These hydrophobic groups tend to associate with one another in an aqueous solution to form an inter/intra molecular association. As a result, the solution viscosity is increased and the viscosity is relatively insensitive to salts as compared to polymers without the hydrophobic groups.

In certain embodiments, the composition contains a second polymer that may be selected from anionic or ampholytic polymers, which may (but need not) be alkali swellable polymers. The polymer or alkali swellable polymer preferably has a molecular weight of at least 100,000 and may (but need not) incorporate associative properties as described above by including copolymerizable surfactants and/or block copolymers as pendent groups or end groups. It is preferred that the polymer be based on a vinyl backbone.

The second polymer preferably has a nominal average molecular weight (M_{w}) of at least 50,000; more preferably at least 100,000; even more preferably at least 250,000 and most preferably 500,00 to 750,000. It is preferred that the polymer be based on a vinyl backbone.

Suitable anionic polymers for use as the second polymer of compositions according to the invention may be prepared by the reaction of one or more acrylic, urethane, styrene, and/or acrylamide based monomers during or after the polymerization or from the copolymerization of one or more of the monomers listed above with anionic monomers. Such anionic monomers may include, without limitation, acrylic acid, methacrylic acid, maleic acid, maleic anhydride, fumaric acid, itaconic acid, vinyl acetate, methacrylamide, styrene sulfonic acid, 2-acrylamido-2-methylpropane sulfonic acid and the like, and water soluble salts thereof. The preferred anionic monomers include acrylic acid, methacrylic acid, maleic acid, vinyl or styrene sulfonates and 2-acrylamido-2-methylpropane sulfonic acid; salts thereof; and combinations thereof. Copolymers of acrylamide and/or another nonionic monomer with more than one of the aforementioned anionic monomers are also within the scope of the invention.

The molar percentage of the comonomers in the second polymer may vary within certain limits, provided that the total adds up to 100%. The anionic charge density will vary from about 0% to 99%, preferably 5% to 90%, and most preferably 15% to 75%. The composition, anionicity, and molecular weight of the copolymer may be optimized for the particular earth formation and water conditions in order to achieve the desired drilling, boring, or excavation and earth supporting functions.

The anionic copolymer of the invention may be further modified by incorporating certain cationic monomers in the polymer forming ampholytic polymers. The cationic monomers may include, without limitation, diallyldimethylammonium chloride, quaternized dimethylaminoethyl methacrylates, N,N-dimethylaminopropyl methacrylamide, and combinations thereof. These cationic constituents may be reacted to form acid salts or quaternized using methyl chloride or dimethyl sulfate.

In certain embodiments, the polymer may include polymers having both cationic and anionic functional groups. This may include a mixture or blend of cationic and anionic polymers including but not limited to the following:
1. Anionically modified polymeric co-additives including polyacrylamides, acrylics, polyacrylates, styrene-butadiene copolymers, styrene-butadiene-acrylic copolymers, polyethers and the like, including synthetic polymers and natural polymers which may be modified, reacted and grafted, etc.
2. Nonionic based co-additives such as butadienes, polyurethanes and the like, including synthetic polymers and natural polymers which may be modified, reacted and grafted, etc.
3. Cationic co-additives such as polyacrylamides, polyacrylamide/formaldehyde (Mannich polymers), polyDADMACs, polyamines, polyMAPTACs, polyethylene imines and the like, including synthetic polymers and natural polymers which may be modified, reacted and grafted to these cationic polymers.
4. Ampholytic polymer mixtures may be one or more associative or grafted co additive polymers as described above, in a water based medium.

If one of the polymers in the composition is a cationic polymer, it may be a homopolymer or copolymer such as a cationic modified polyacrylamide, a polyamine, a Mannich polymer, polyDADMAC, polyMAPTAC, polyethyleneimine, or the like polymers containing monomer units which may be selected from quaternized dimethylaminoethyl methacrylates and water soluble salts thereof, (methacryloxy)ethyl dimethyl amine, (methacrylamido)propyl dimethyl amine, (acryloxy)ethyl dimethyl amine, (acrylamido)methylpropyl dimethyl amine, and the acid salts and the methylsulfate and methyl chloride derivatives thereof, dimethyl diallyl ammonium chloride, diethyl diallyl ammonium chloride, dimethyl allyloxyethyl amine, and any mixtures.

The alkali swellable, water dispersible polymer may be selected from anionic. Cationic, ampholytic or nonionic polymers and may also include one or more ampholytic polymers or associative polymers as described above.

Anionic, cationic, nonionic, and ampholytic natural polymers such as cellulosics, starches, biopolymers, gums, etc which are unreacted, reacted, modified or grafted may are also within the scope of this invention. These natural polymers may also be hydrophobically modified or associative. These natural polymer may incorporate associative copolymers or functional surfactants containing hydrophobic moieties, where the hydrophobic moieties reversibly associate to form networks in an aqueous solution. These networks can be reversibly disrupted by the application of a shear force and subsequently re-formed upon the discontinuation of the force.

In certain embodiments the polymer may be stabilized in and oil and water emulsion form or a dried emulsion form with surfactants, soaps and/or detergents prepared as synthetics or derivatized natural substances. These surfactants, soaps and/or detergents include but are not limited to sulfo-succinates that are mono or diesters, ether sulfonates, sulfonated oils, ether carbonates, ether phosphates, stearates and other fatty acid esters with or without ethoxylation and/or propylation and/or butyoxalation, alkyl sulfates of C₁ to C₂₄, functional ethoxylates, alkoxylates including phenol, diphenol, alkyl C₁ to C₂₄ produced using ethyleneoxide, propylene oxide or butylene oxide or mixtures and their derivatives with methacrylic anhydride, isopropenyl styrene-isocyanate, maleic anhydride, itaconic anhydride, fumaric anhydride or their corresponding acids to form esters, glucosides, disulfonates, betaines, quaternary ammonium salts, alkyl sulfates, olefin sulfonates, isethionates, hydrotropes, alkyl phenols with ethoxylation and/or propoxylation, and/or butoxylation, amine oxides and their derivatives, block copolymers, sorbitan fatty esters with or without ethoxylation, propyoxylation or butoxylation, styrene sulfonate, xylenesulfonate or naphthalene sulfonates and their derivatives.

One novel aspect of the invention lies in the selection of the proper dry stabilized water-soluble silicate, which can be in contact with other reactive polymers without detriment to these polymers during storage for prolonged periods of time. In especially preferred embodiments, the silicate generates hydroxyl ions when dissolved in water, thereby reducing or eliminating the need to add a hydroxide base in the composition to obtain a sufficiently alkaline fluid. It has been discovered that sodium or potassium metasilicate is especially suitable for this purpose.

The silicate may be an sodium or potassium salt may be selected from selected from sodium orthosilicate (Na₄SiO₄), sodium metasilicate (Na₂SiO₃.5H₂O), sodium sesquisilicate (3Na₂O.2SiO₂.11H₂O), sodium disilicate (Na₂O.2SiO₂.xH₂O) combinations thereof of sodium or potassium salts.

The metal oxides, if used, may be selected from untreated fumed silica, untreated fumed alumina, treated fumed silica, treated fumed alumina and silica. Treated fumed metal oxides and silica may be hydrophilic to hydrophobic in nature. The untreated (hydrophilic) silicas and metal oxides may be treated with silanes such as dimethyldichlorosilane, hexamethyldisilazane, etc., or with silicone fluids. These silicas provide hydrophobicity, rheology control, reinforcement, and free flow. These materials provide one or more of the following contributions: slurry rheology, slurry structuring, slurry densification, and fluid loss control. These materials may be added as an ingredient in the present dry composition or post-added to a hydrated variation of the present composition.

If glass, ceramic or metal oxide beads, bubbles, or spheres are included in the composition, these may be solid, honeycombed, or hollow. These materials provide one or more of the following contributions: fluid loss control or plugging; slurry densification; slurry structuring; adsorption of free cations; and slurry rheology. Suitable glass particles include those sold by Potters Industries under the trade names Sphericel®, Spheriglass®, Q-Cel®, Oil Drilling Fine Grade Beads, and Oil Drilling Coarse Grade Beads. These products come as is or with coupling agent. Suitable metal oxides include zeolites. These materials may be added as an ingredient in the present dry composition or post-added to a hydrated variation of the present composition

Naturally occurring siliceous clays have also proven beneficial within variations of the present composition for improved fluid loss control and slurry densification. Most preferable are clays used in the manufacture of ceramics such as ball clays; other clays containing kaolinite, with some quantity of mica, silica and/or quartz are also preferable. Volcanic clays including less reactive or hydratable grades of montmorillonite may also be utilized. It is preferable that more reactive grades of montmorillonite such as high grade, high yield sodium montmorillonite not be utilized. These clays may be added as an ingredient in the present composition or post-added to a hydrated variation of the present composition.

The compositions may also contain sodium aluminate, inorganic buffers, polycationic additives, soil or mineral solids and other materials as disclosed in the prior art and in U.S. Pat. Nos. 5,407,909; 5,663,123; and 6,248,697, the entire disclosures of which are hereby incorporated herein by reference.

One particularly preferred composition according to the present invention contains the following materials:

| | |
|---|---|
| Sodium metasilicate | 36-38% |
| Anionic polyacrylamide | 55% |
| Nonionic cross-linked PHPA | 2% |
| Cationic polyacrylamide | 2% |
| Alkali-swellable thickener | 3-5% |
| Ceramic grade clay | 0% to 15% |

Another particularly preferred composition according to the present invention contains the following materials:

| | |
|---|---|
| Sodium metasilicate | 45% |
| Anionic polyacrylamide | 30-35% |
| Nonionic cross-linked PHPA | 5% |
| Cationic polyacrylamide | 5% |
| Alkali-swellable thickener | 8-13% |
| Ceramic grade clay | 0% to 15% |

Another particularly preferred composition according to the present invention contains the following materials:

| | |
|---|---|
| Sodium metasilicate | 25% to 45% |
| Anionic polyacrylamide | 5% to 35% |
| Associative ampholytic polyacrylamide | 5% to 50% |
| Nonionic cross-linked PHPA | 3% to 10% |
| Cationic polyacrylamide | 2% to 10% |
| Cationic poly DADMAC's | 2% to 15% |
| Alkali-swellable thickener | 5% to 35% |
| Ceramic grade clay | 0% to 25% |

An alternative composition according to the present invention contains about 25 to about 50 weight percent of said silicate, about 10 to about 40 weight percent of an anionic polyacrylamide, about 2 to about 10 weight percent of a cross-linked, polyacrylamide or acrylic; about 2 to about 10 weight percent of a polyacrylamide having a cationic charge density of less than about 25%; and about 5 to about 40 weight percent of an alkali-swellable polymer, where the silicate generates hydroxyl ions upon dissolution in water. A more preferred composition contains about 35 to about 50 weight percent of said silicate; about 20 to about 40 weight percent of an anionic polyacrylamide; about 2 to about 10 weight percent of a cross-linked, polyacrylamide or acrylic; about 2 to about 10 weight percent of a polyacrylamide having a cationic charge density of less than about 25%; and about 7 to about 25 weight percent of an alkali-swellable polymer, where the silicate generates hydroxyl ions upon dissolution in water.

Another alternative composition according to the present invention contains about 30 to about 50 weight percent of sodium metasilicate; about 10 to about 46 weight percent of a polyacrylamide with anionic functionality; about 5 to about 10 weight percent of a cross-linked, polyacrylamide or acrylic; about 2 to about 40 weight percent of a polyacrylamide having cationic functionality with a charge density of less than about 65%; and about 5 to about 40 weight percent of an alkali-swellable polymer. A more preferred composition contains about 30 to about 50 weight percent of sodium metasilicate; about 10 to about 36 weight percent of an polyacrylamide with anionic functionality; about 5 to about 10 weight percent of a cross-linked, polyacrylamide or acrylic; about 2 to about 40 weight percent of a polyacrylamide having cationic functionality with a charge density of less than about 65%; and about 10 to about 25 weight percent of an alkali-swellable polymer.

Yet another alternative composition according to the present invention contains about 25 to about 50 weight percent of silicate; about 5 to about 35 weight percent of a polyacrylamide with anionic functionality; about 5 to about 50 weight percent of an ampholytic polyacrylamide, which may or may not be associative or hydrophobically modified; about 3 to about 10 weight percent of a cross-linked, polyacrylamide or acrylate; about 2 to about 50 weight percent of a polymer with cationic functionality; about 5 to about 40 weight percent of an ampholytic or non-ampholytic alkali-swellable polymer which may or may not be associative or hydrophobically modified; and about 0 to about 25 weight percent of a clay, where the silicate generates hydroxyl ions upon dissolution in water. A more preferred composition contains about 25 to about 50 weight percent silicate; about 5 to about 35 weight percent of a polyacrylamide with anionic functionality; about 10 to about 40 weight percent of an ampholytic polyacrylamide, which may or may not be associative or hydrophobically modified; about 5 to about 10 weight percent of a cross-linked, polyacrylamide or acrylate; about 2 to about 50 weight percent of a polymer with cationic functionality; about 10 to about 30 weight percent of an ampholytic or non-ampholytic alkali-swellable polymer, which may or may not be associative or hydrophobically modified; and about 0 to about 25 weight percent of a clay, where the silicate generates hydroxyl ions upon dissolution in water.

These compositions may be dissolved or dispersed in water to provide an excavating fluid. The silicate in the excavating fluid permeates the weak or unstable layers of granular earth material or fills that are penetrated by the excavating or boring machinery. The silicate reacts with the naturally occurring soil components under excavation, along with any introduced crosslinking or catalytic agents. The degree of strengthening, increased cohesion, or hardening is developed by enhancing or preventing alteration of weak bonds among the granular earth material, or by forming a glasslike siliceous matrix within the soils present. This effect is achievable in granular formations and soils such as gravel and sand; in filled areas and irregular materials such as rubbleized concrete and mixed fills in and around old foundation systems; in sand-bearing soils such as clayey sand, sandy clay, silty sand and sandy silt; and in other permeable, clastic, granular or partially-granular earth formations such as glacial tills, oolite, shell beds, vugular or fractured rocks, rock washes and decomposed rock materials.

The time required for the silicate to react with and significantly increase the stability of the earth formation is sufficiently short as to be useful to the excavator or driller to improve the efficiency of the excavating process or allow for the continuation of excavation in the absence of traditional soil stabilization pre-treatments such as grouting or post-treatments such as backfilling with earth, lean mix, or concrete. This improvement not only significantly impacts the logistics of excavating unstable soil, but reduces the overall cost of the excavation process.

This differs from classical methods of soil stabilization (ground improvement) wherein silicate compounds and usually calcium bearing agents and other compounds were separately injected into the ground with specially-designed equipment to stabilize the earth formation prior to attempting excavation or other steps in the geoconstruction process. This process of ground improvement is currently practiced prior to beginning many types of boring, excavating or geoconstruction. Until now it was always assumed that the soil needed to be stabilized prior to excavation, to make it excavable. In the excavation and construction of structures such as tunnels, barrettes, bored piles and slurry walls, the prior step of ground improvement may now be eliminated in many cases through the use of the present invention. The invention allows the direct excavation and simultaneous strengthening of unstable, low cohesion or weak zones or areas. The invention is thus useful and cost-beneficial to the industry.

The compositions and methods disclosed herein provide a novel method of delivery of a ground-improvement system in a practical and especially efficient manner that incorporates ground improvement into the process of excavating or boring while significantly reducing the potential for variable performance due to mixing errors. The invention adds strength to a freshly excavated area that will last long enough to keep its shape through the completion of concrete placement (or the placing of casing or other downhole components, in the case of wells). It is compatible with polymer fluid systems currently in use in the industry, as well as with fluids based on bentonite and other finely divided solids. One of the main uses of the invention is in bringing about adequate stability to running sands and loose earth layers typically containing mineral materials in an unstable mixture that is capable of sloughing or collapsing into the freshly cut or drilled areas.

The composition of the invention is added to water or an aqueous base to produce a dual-purpose excavating and soil-strengthening fluid. Preferably the amount of dry mix added is sufficient to provide a Marsh Funnel Viscosity of at least 28 seconds per quart, more preferably at least about 35 seconds per quart, and most preferably at least about 45 seconds per quart. In one preferred embodiment, the fluid has a pH of at least 9.0 and a Marsh Funnel Viscosity of at least 60 seconds per quart.

This dual-purpose fluid, produced by simply adding a composition of the invention to water, may be applied as is or, more preferably, may be augmented once in solution with additional hydroxyl alkalinity and/or polycationic additives as described in U.S. Pat. No. 5,663,123. It may also be further augmented from time to time with additional water-swellable polyacrylamides or polyacrylates, cationic polymers and hydroxides as described in U.S. Pat. Nos. 5,407,909 and 5,663,123. Under certain conditions where the silicate contained in the composition of the invention may be significantly re-solubilized through the addition of a hydroxyl donor, a catalytic agent or cross-linking agent for the solubilized silicate may be added as described in U.S. Pat. No. 6,248,697.

Moreover, persons of skill in the art will appreciate that compositions according to the present invention greatly simplify the use of excavation fluids by field operators because the dry, premixed compositions already contain the correct proportions of the appropriate components and additives for producing a functional excavation fluid. By providing the operator with a composition that contains the correct ratios of all of these materials, the quality of the excavation fluid becomes significantly more consistent, resulting in more reliable performance with reduced risk of operator error.

The use of compositions according to the present invention also improves the quality of the excavation. When all of the components are present in the optimal ratios, the fluid will correctly structure in situ and then properly bond to earthen formations during excavation with the following beneficial results:
a. increased soil cohesion through chemical adhesion which results from electrochemical association of the anionic and cationic sites to the respective receptor sites within the formation.
b. sidewall stabilization through the formation of a polymeric membrane or gel coating at and within the formation sidewall. The total growth in thickness of this membrane back into the fluid column or chamber is limited due to the increased concentration and type of water insoluble, hydrophobic and/or amphiphilic groups within the membrane as it forms, which at a point of membrane growth in thickness reach a critical ratio and change the membrane's nature from hydrophilic to hydrophobic. This membrane then creates a barrier upon which the water based fluid column in the excavation relies to apply positive differential pressure against the sidewall.

### EXAMPLES

1. A dry blend of soluble polymers with the silicate according to the invention was prepared at a ratio of 56 percent water-soluble or water-swellable polymers consisting of 36% of an anionic polyacrylamide with a nominal molecular weight of approximately 20,000,000 M_{w} and an approximate charge density of 40%; 10% of an anionically affected alkali-swellable polymer styrene-butadiene copolymer with a nominal molecular weight of approximately 500,000 M_{w}; 5% of a cationic polyacrylamide with a nominal molecular weight of approximately 10,000,000 M_{w}; 5% of a nonionic highly crosslinked polyacrylamide with a nominal molecular weight of about with high molecular weight (As polymer is highly crosslinked it is impossible to know Mw); and 44 percent water-soluble sodium metasilicate. A sample of the blend was mixed into water at a ratio of 2 kg/m³ of water and stirred in a lightning mixer for 10 minutes at 600 rpm with a three-paddled stirring rod. The resulting fluid had a pH of 9.8 and a Marsh Funnel viscosity of 63 seconds per quart.

The dry blend of polymers and silicate was allowed to stand for 4 months, after which it was observed for physical appearance and retested for viscosity and pH development. The blend was a free-flowing, white, dry powdery and granular composition just as when initially produced. A sample of the blend was mixed at a ratio of 2 kg/m³ of water and stirred in a lightning mixer for 10 minutes at 600 rpm with a three-paddled stirring rod. The resulting fluid had a pH of 9.7 and a Marsh Funnel Viscosity of 61 seconds per quart. These measurements confirmed that the corrosive silicate had not caused degradation or decomposition of the water-soluble polymers in the blend.

2. A scaled-up pilot blend of a composition according to the present invention, containing the same formulation as in Example 1, was prepared. An initial control sample was mixed at a ratio of 2 kg/m³ of water and stirred in a lightning mixer for 10 minutes at 600 rpm with a three-paddled stirring rod. The resulting fluid had a pH of 9.9 and a Marsh Funnel Viscosity of 65 seconds per quart.

A second control sample was obtained from packaged pails of the blended material after six months of storage in a public warehouse. The sample was a free-flowing, white, dry powdery and granular composition just as when initially produced. The sample was mixed into water at a ratio of 2 kg/M³ and stirred in a lightning mixer for 10 minutes at 600 rpm with a three-paddled stirring rod. The resulting fluid had a pH of 9.7 and a Marsh Funnel Viscosity of 64 seconds per quart, again confirming that the corrosive silicate had not degraded or decomposed the water-soluble polymers in the blend under typical storage conditions.

3. A full-scale field trial of the pilot blend was conducted after eighteen months of storage. Before testing the composition of the invention, the contractor had tested three conventional synthetic slurries, two of which were described as PHPA slurries and the third of which was a synthetic vinyl. One of the PHPA's was reported to be from a supplier based in Rome, Italy and the second PHPA and vinyl were reported to be from a supplier based in Parma, Italy. The contractor reported that he had continuously experienced significant instability of the excavations from approximately 20 meters to 30 meters below ground level using all three of the above technologies. Due to this instability he had not been able to construct of acceptable piles that passed the nondestructive testing specified in his contract. Most of the piles showed some form of anomaly, such as entrained defects from sloughing or caving earth during the concreting process or significant concrete over-pour volumes due to excavation sloughing and collapses during excavation. Each of the above polymers was applied at a dosage of approximately 1 to 1.55 kg/M³ of water and recycled excavation fluid. The excavation fluid's pH was also increased to 10 using soda ash.

The composition of the invention was mixed at a dosage of 2.2 kg/M³ with water to produce slurry with a pH of approximately 10.0 (as tested with four band colorimetric pH indication strips) and a Marsh Funnel Viscosity of approximately 85 to 90 seconds per quart. Four total test piles were drilled in exactly the same manner and using the identical equipment that had been used to drill the other piles had been drilled. Excavation went along very smoothly with no collapses on the first two piles. Each completed pile produced an acceptable, high-quality foundation element.

In addition to resolution of the problems mentioned above, i.e. rejection of many of the piles on quality and significant over-runs in concrete consumption due to collapsing of the piles during excavation, the contractor also desired the option of excavating a pile and holding it open overnight to increase his rate of production. Due to the success of the first two piles, it was the decided to drill a third pile to approximately 28 meters at the end of the day, which left the very weak soils in the 20 to 30 meter layer exposed. This pile was left overnight and re-measured in the morning to test the extent of the slurry's soft grouting efficacy. The next morning the pile measured 27.8 meters in depth, with the 0.20 meters being fine colloidal sedimentation that had precipitated out of suspension overnight. The pile was completed and concrete was poured, yielding a high-quality foundation element.

During excavation of the fourth pile, the excavation fluid was allowed to drop approximately ten meters below the ground level, which was below the natural water table. Even under such extreme and adverse conditions, the weak soil layer from 20 to 30 meters only experienced a slight degree of sloughing.

In conclusion, the composition of the invention was used to produce the only excavation fluid capable of properly stabilizing the very weak or very low-cohesion soil layers and allowing acceptable foundation elements to be constructed.

4. A dry blend of soluble polymers with the silicate according to the invention was prepared at a ratio of 65 percent water-soluble or water-swellable polymers, which consisted of
20% of an anionic polyacrylamide with a nominal molecular weight of approximately 20,000,000 M_{w} and an approximate charge density of 40%;
5% of an alkali-swellable styrene-butadiene copolymer of moderate anionic charge with a nominal molecular weight of approximately 500,000 M_{w};
10% of a non-ionically affected copolymer with a nominal molecular weight of approximately 500,000 M_{w};
20% of an ampholytically affected polyacrylamide copolymer having 40% nominal cationic charge and 60% nominal anionic charge and a nominal molecular weight of approximately 15,000,000 M_{w};
5% of a highly cross-linked polyacrylamide with nominal anionic charge density of 0-5% and a nominal granular size of 1.0 mm to 2.0 mm; and
5% of a cationically affected polyDADMAC polymer with a nominal intrinsic viscosity less than 1.0 and a nominally high cationic charge density;
and 35% of a water-soluble sodium metasilicate.
   A sample of the blend was mixed into water at a ratio of 2 kg/M³ of water and stirred in a lightning mixer for 15 minutes at 600 rpm with a three-paddled stirring rod. The resulting fluid had a pH of 9.2 and a Marsh Funnel viscosity of 59 seconds per quart. The hydrated fluid also displayed a plurality of rice-shaped semi-soluble, deformable gels.

The dry blend of polymers and silicate was allowed to stand for 4 weeks, after which it was observed for physical appearance and retested for viscosity and pH development. The blend was a free-flowing, white, dry powdery and granular composition just as when initially produced. A sample of the blend was mixed at a ratio of 2 kg/m³ of water and stirred in a lightning mixer for 15 minutes at 600 rpm with a three-paddled stirring rod. The resulting fluid had a pH of 9.0 and a Marsh Funnel Viscosity of 61 seconds per quart. These measurements confirmed that the corrosive silicate had not caused degradation or decomposition of the water-soluble polymers in the blend. The hydrated fluid also displayed a plurality of rice-shaped semi-soluble, deformable gels.

While the invention has been described with reference to certain preferred embodiments, obvious modifications and alterations are possible by those skilled in the art. Therefore, it is intended that the invention include all such modifications and alterations to the full extent that they come within the scope of the following claims or the equivalents thereof.

1. A dry flowable solid composition comprising at least one water dispersible synthetic polymer and at least one silicate.

2. The composition of claim 1 wherein the silicate is selected from the group consisting of sodium and potassium orthosilicates, sodium and potassium sesquisilicates, sodium and potassium metasilicates, sodium and potassium disilicates and combinations thereof.

3. The composition of claim 1 wherein the silicate releases soluble hydroxyl ions upon dissolution into an aqueous solution.

4. The composition according to claim 1, wherein said at least one water dispersible polymer comprises one or more polymers containing at least one vinyl based monomer.

5. The composition of claim 4 wherein said at least one water dispersible polymer is a hydroxy alkali swellable synthetic polymer comprising an anionic functional group.

6. The composition of claim 1, wherein said at least one water dispersible polymer is ampholytic.

7. The composition of claim 1, where said at least one water dispersible polymer is associative.

8. The composition of claim 7 wherein the associative polymer comprises water insoluble or hydrophobic moieties, said moieties reversibly associating with one another to form networks in aqueous solution, wherein said networks are capable of being reversibly disrupted by application of a shear force and of being re-formed upon discontinuation of said force.

9. The composition of claim 1, wherein said at least one water dispersible polymer is ampholytic and associative.

10. The composition of claim 1 wherein at least one of said polymers has a molecular weight greater than 50,000.

11. The composition of claim 1 wherein at least one of said polymers has a molecular weight greater than 1,000,000.

12. The composition of claim 1, further comprising at least one additional polymer having at least one vinyl based monomer incorporated therein during synthesis of the additional polymer.

13. The composition of claim 12, wherein said at least one additional polymer is a polymeric reaction product of one or more monomers selected from the group consisting of nonionic, associative, cationic and anionic monomers, wherein at least one of said nonionic monomers is selected from the group consisting of styrene, C₁ to C₂₀ acrylates, C₁ to C₂₀ methacrylates, vinyl acetate acrylonitrile, methylacrylonitrile, isopropenyl styrene isocyanate, alpha, alpha-dimethyl-m-isopropenyl bezyl isocyanate, acrylamide, methacrylamide, β-hydroxyethyl acrylate, and allyl alcohol and allyl chloride, hydroxypropyl methacrylate, hydroxyethyl acrylate, hydroxylethyl methacrylate, 2,3 glycididyl methacrylate, lauryl acrylate, butanediol monoacrylate, 2-hydroxypropyl acrylate, 2-hydroxyethyl acrylate, isobutyl acrylate, 2-ethylhexyl acrylate, tertiarybutyl methacrylates, tertiarybutyl acrylate, decyl methacrylate isomers, lauryl methacrylate, stearyl methacrylates, and any di -or tri-acrylate or methacrylate functional monomers, ethylene, vinyl acetate, C₃ to C₂₀ alpha olefins, 3-butadiene, isoprene and chloroprene and acrylic acid, methacrylic acid, maleic acid maleic acid, and/or maleic anhydride or fumaric anhydride or itaconic anhydride or methacrylic anhydride, with pre-reaction with any nonionic surfactant that is amine or hydroxyl terminal; wherein at least one said associative monomers is selected from the group consisting of alkoxylates including sorbitol, monosaccharide, starch, or polysaccharide, phenol, diphenol, alkyl C₁ to C₂₄ produced using 0 to 100 moles ethylene oxide, propylene oxide or butylene oxide or mixtures and their derivatives with methacrylic anhydride, isopropenyl styrene isocyanate, alpha, alpha-dimethyl-m-isopropenyl benzyl isocyanate, maleic anhydride, itaconic anhydride, fumaric anhydride or their corresponding acids to form bonded reactive monomer-surfactant combinations; wherein at least at least one of said cationic monomers is selected from the group consisting of dimethyl or diethyl aminoethylmethacrylate or dimethyl diethyl aminopropyl(meth)acrylamide, N,N-dimethylamino propylacrylamide, N,N-dimethylamino propylacrylamide, methyl chloride quat, diacetone acrylamide, hydroxy ethyl acrylamide, N,N-dimethyl acrylamide, dimethylaminoethyl acrylate, N-isopropylacrylamide, N-alkylacrylamides, N,N-diethyl acrylamide, dimethyl acrylamide, dimethylamino propylacrylamide; and wherein at least one of said anionic monomers is selected from the group consisting of acrylic acid, methacrylic acid, β-carboxyethyl acrylate, maleic acid, maleic anhydride, fumaric acid, fumaric anhydride, itaconic acid, styrene sulfonic acid, vinyl sulphonate, styrene phosphonate, 2-acrylamido-2-methylpropane sulfonic acid, vinyl sulfoacid, sulfoalkylacrylates, sulfoalkyl acrylamides, allyl sulfonic acid, methallyl sulfonic acid, allyl glycidyl ether sulfonate, vinyl acetic acid, allylacetic acid, 4-methyl-4-pentenoic acid, α-haloacrylic acid, β-hydroxyethyl acrylate, β-carboxyethyl acrylate and water soluble salts thereof, and allylic monomers.

14. The composition of claim 13, where the additional polymer is alkali swellable and associative and ampholytic.

15. The composition of claim 13 wherein said at least one additional polymer has a molecular weight greater than 50,000.

16. The composition of claim 13 wherein said at least one additional polymer has a molecular weight greater than 100,000.

17. The composition of claim 13, wherein the at least one additional polymer further comprises at least one anionic monomer.

18. The composition of claim 17, wherein the anionic monomer is selected from the group consisting of acrylic acid, methacrylic acid, maleic acid, maleic anhydride, fumaric acid, fumaric anhydride, itaconic acid, styrene sulfonic acid, 2-acrylamido-2-methylpropane sulfonic acid, vinyl sulfonic acid, sulfoalkylacrylates, sulfoalkyl acrylamides, allyl sulfonic acid, methallyl sulfonic acid, allyl glycidyl ether sulfonate, vinyl acetic acid, allylacetic acid, 4-methyl-4-pentenoic acid, α-haloacrylic acid, β-hydroxyethyl acrylate, β-carboxyethyl acrylate and water soluble salts thereof.

19. The composition of claim 12, wherein the additional polymer is associative.

20. The composition of claim 19 wherein the associative polymer comprises hydrophobic moieties, said moieties reversibly associating with one another to form networks in aqueous solution, wherein said networks are capable of being reversibly disrupted by application of a shear force and of being re-formed upon discontinuation of said force.

21. The composition of claim 12, wherein the additional polymer is alkali swellable.

22. The composition of claim 12, wherein the additional polymer is ampholytic.

23. The composition of claim 12, wherein the additional polymer is alkali swellable and ampholytic.

24. The composition of claim 12, wherein the additional polymer is alkali swellable and associative.

25. The composition of claim 24 wherein the associative polymer comprises hydrophobic moieties, said moieties reversibly associating with one another to form networks in aqueous solution, wherein said networks are capable of being reversibly disrupted by application of a shear force and of being re-formed upon discontinuation of said force.

26. A composition according to claim 1, further comprising at least one further polymer having at least one cationic monomer incorporated therein during synthesis thereof.

27. The composition of claim 26, wherein said at least one further polymer is a polymeric reaction product of one or more monomers selected from the group consisting of ethyleneimine, quaternized dimethylaminoethyl methacrylates, (methacryloxy)ethyl dimethyl amine, (methacrylamido)propyl dimethyl amine, (acryloxy)ethyl dimethyl amine, (acrylamido)methylpropyl dimethyl amine, dimethyl diallyl ammonium chloride, diethyl diallyl ammonium chloride, dimethyl allyloxyethyl amine; the water soluble salts, acid salts, methylsulfate derivatives and methyl chloride derivatives thereof; and mixtures thereof.

28. A composition according to claim 1, wherein said at least one synthetic polymer comprises a polymeric reaction product of a dihaloalkane or epichlorohydrin with an amine.

29. A composition according to claim 1, further comprising at least one polymer that is a modified or unmodified natural polymer, grafted natural polymer, and hydrophobically modified versions of said natural polymer and said grafted natural polymer.

30. A composition according to claim 29, wherein said natural polymer is selected from the group consisting of cellulosics, reacted cellulosics, modified cellulosics, starches, reacted starches, modified starches, polysaccharides, reacted polysaccharides, modified polysaccharides, gums, reacted gums, modified gums, biopolymers, reacted biopolymers, and modified biopolymers; combinations thereof, and blends and grafts thereof.

31. A composition according to claim 30, wherein said natural polymer comprises associative copolymers or functional surfactants containing hydrophobic moieties, said moieties reversibly associating with one another to form networks in aqueous solution, wherein said networks are capable of being reversibly disrupted by application of a shear force and of being re-formed upon discontinuation of said force.

32. A composition according to claim 1 wherein said at least one silicate comprises at least about 20 weight percent of said composition and said at least one water-dispersible polymer comprises at least about 20 weight percent of said composition.

33. A composition according to claim 32 wherein said at least one silicate comprises sodium metasilicate and said at least one water-dispersible polymer comprises a polyacrylamide with anionic functionality.

34. A composition according to claim 33, further comprising at least one polyacrylamide having a cationic charge density of less than about 25%.

35. A composition according to claim 32 comprising (a) about 20 to about 50 weight percent of said silicate; (b) about 0 to about 40 weight percent of an anionic polyacrylamide; (c) about 2 to about 10 weight percent of a cross-linked polyacrylamide; (d) about 2 to about 10 weight percent of a polyacrylamide having a cationic charge density of less than about 25%; and (e) about 3 to about 50 weight percent of an alkali-swellable polymer, wherein said silicate generates hydroxyl ions upon dissolution in water.

36. A composition according to claim 35 wherein said at least one silicate comprises sodium metasilicate.

37. A composition according to claim 35 wherein said alkali-swellable polymer incorporates associative copolymers or functional surfactants containing hydrophobic moieties, said moieties reversibly associating with one another to form networks in aqueous solution, wherein said networks are capable of being reversibly disrupted by application of a shear force and of being re-formed upon discontinuation of said force.

38. A composition according to claim 37, wherein at least one of said associative polymers is a polymeric reaction product of one or more monomers selected from the group consisting of nonionic, anionic and cationic monomers, wherein at least one of said nonionic monomers is selected from the group consisting of styrene, C₁ to C₂₀ acrylates, C₁ to C₂₀ methacrylates, vinyl acetate acrylonitrile, methylacrylonitrile, isopropenyl -styrene isocyanate, alpha, alpha-dimethyl-m-isopropenyl benzyl isocyanate, vinyl sulphonate, styrene phosphonate, acrylamide, methacrylamide, β-hydroxyethyl acrylate, and allyl alcohol and allyl chloride, hydroxypropyl methacrylate, hydroxyethyl acrylate, hydroxylethyl methacrylate, 2,3 glycididyl methacrylate, lauryl acrylate, butanediol monoacrylate, 2-hydroxypropyl acrylate, 2-hydroxyethyl acrylate, β-hydroxyethyl acrylate, isobutyl acrylate, 2-ethylhexyl acrylate, tertiarybutyl methacrylates, tertiarybutyl acrylate, decyl methacrylate isomers, lauryl methacrylate, stearyl methacrylates, and any di -or tri-acrylate or methacrylate functional monomers, ethylene, vinyl acetate, C₃ to C₂₀ alpha olefins, 1,3-butadiene, isoprene; wherein at least one of said anionic monomers is selected from the group consisting of acrylic acid, methacrylic acid, β-carboxyethyl acrylate, maleic acid, maleic anhydride, fumaric acid, fumaric anhydride, itaconic acid, styrene sulfonic acid, 2-acrylamido-2-methylpropane sulfonic acid, styrene sulfonic acid, vinyl sulfoacid, sulfoalkylacrylates, sulfoalkyl acrylamides, allyl sulfonic acid, methallyl sulfonic acid, allyl glycidyl ether sulfonate, vinyl acetic acid, allylacetic acid, 4-methyl-4-pentenoic acid, α-haloacrylic acid, β-carboxyethyl acrylate and water soluble salts thereof, acrylamides, methacrylamide, β-hydroxyethyl acrylate, β-carboxyethyl acrylate and allylic monomers; and wherein at least one of said cationic monomers is selected from the group consisting of dimethyl or diethyl aminoethylmethacrylate or dimethyl diethyl aminopropyl(meth)acrylamide, N,N-dimethylamino propylacrylamide, N,N-dimethylamino propylacrylamide, methyl chloride quat, diacetone acrylamide, hydroxy ethyl acrylamide, N,N-dimethyl acrylamide, dimethylaminoethyl acrylate, N-isopropylacrylamide, N-alkylacrylamides, N,N-diethyl acrylamide, dimethyl acrylamide, dimethylamino propylacrylamide.

39. A composition according to claim 32 comprising about 20 to about 50 weight percent of sodium metasilicate; about 0 to about 46 weight percent of a polyacrylamide with anionic functionality; about 2 to about 10 weight percent of a cross-linked polyacrylamide or acrylic; about 2 to about 50 weight percent of a polyacrylamide having cationic functionality with a charge density of less than about 75%; and about 5 to about 50 weight percent of an alkali-swellable polymer.

40. A composition according to claim 1 wherein said composition comprises at least one anionic polymer and at least one cationic polymer.

41. A composition according to claim 40 wherein the anionic polymer comprises a polyacrylamide polymer.

42. A composition according to claim 40 wherein the cationic polymer comprises a polyacrylamide polymer.

43. A composition according to claim 40 wherein the cationic polymer comprises polyethyleneimine.

44. A method of stabilizing an excavation, comprising the steps of mixing a composition according to claim 1 with water to provide an earth-stabilizing fluid;
introducing said fluid into the excavation; and enlarging the excavation while the excavation contains the earth stabilizing fluid.

45. A method of preparing an earth-stabilizing fluid, comprising the step of mixing a composition according to claim 1 with water.

46. The method of claim 45, wherein the composition according to claim 1 is provided at a ratio of about 0.25 to about 4.0 kilograms per cubic meter of water.

47. The method of claim 45, wherein the fluid has a pH greater than about 8.0 and a Marsh Funnel Viscosity of at least about 45 seconds per quart.

48. The method of claim 45, whereby the silicate releases soluble hydroxyl ions when it is mixed with the water.

49. The method of claim 45, further comprising the step of treating the fluid with at least one chemical additive selected from the group consisting of cationic materials, anionic materials, ampholytic materials, nonionic materials, natural materials, earthen colloids, and crosslinked polymers.

50. The method of claim 49, wherein the at least one additive is selected from the group consisting of polyamides, polyacrylamides, poly(diallyldimethylammonium chloride)s, polyethyleneimine, cationic polyelectrolytes, quaternized dimethylaminoethyl methacrylates; (acryloxy)ethyl dimethyl amine, (methacryloxy)ethyl dimethyl amine, (methacrylamido)propyl dimethyl amine, (acrylamido)methylpropyl dimethyl amine, dimethyl allyloxyethyl amine; the water soluble salts, acid salts, methylsulfate derivatives and methyl chloride derivatives thereof; dimethyl diallyl ammonium chloride, diethyl diallyl ammonium chloride; and mixtures thereof.

51. The method of claim 45, further comprising the step of treating the fluid with a soluble hydroxide or hydroxyl donor to hydrolyze amide groups therein to carboxyl groups.

52. The method of claim 45 wherein said mixing occurs within an excavation.

53. An earth-stabilizing fluid composition comprising a solid composition according to claim 1 dissolved in an aqueous fluid in an amount sufficient to provide a Marsh Funnel Viscosity of at least about 28 seconds per quart.

54. A fluid composition according to claim 53 having a Marsh Funnel Viscosity of at least about 35 seconds per quart.

55. A fluid composition according to claim 53 having a Marsh Funnel Viscosity of at least about 45 seconds per quart.

56. A fluid composition according to claim 53 further comprising a chemical additive selected from the group consisting of cationic materials, anionic materials, nonionic materials, earthen colloids, and crosslinked polymers

57. A fluid composition according to claim 56, wherein the chemical additive is a polyacrylamide polymer.

58. A fluid composition according to claim 57, wherein some of the amide groups in said polyacrylamide polymer are hydrolyzed in solution to form carboxyl groups by addition of a hydroxyl donor.

59. A composition according to claim 1 wherein said at least one silicate comprises at least about 20 weight percent of said composition and said at least one water-dispersible polymer comprises at least about 5 weight percent of said composition.

60. A composition according to claim 59 wherein said at least one silicate comprises sodium metasilicate and said at least one water-dispersible polymer comprises a polyacrylamide with anionic functionality.

61. A composition according to claim 59 further comprising at least one polyacrylamide with cationic functionality having a charge density of less than about 75%.

62. A composition according to claim 59 comprising about 20 to about 50 weight percent of said silicate; about 5 to about 35 weight percent of a polyacrylamide with anionic functionality; about 0 to about 50 weight percent of an ampholytic polyacrylamide; about 3 to about 10 weight percent of a cross-linked polyacrylamide; about 2 to about 50 weight percent of a polymer with cationic functionality; about 2 to about 15 weight percent of a cationic polyacrylamide; about 3 to about 50 weight percent of an ampholytic or non-ampholytic alkali-swellable polymer; and about 0 to about 25 weight percent of a clay; wherein said silicate generates hydroxyl ions upon dissolution in water.

63. A composition according to claim 62 wherein said at least one silicate comprises sodium metasilicate.

64. A composition according to claim 62 wherein said associative ampholytic polyacrylamide incorporates associative copolymers or functional surfactants containing hydrophobic moieties, said moieties reversibly associating with one another to form networks in aqueous solution, wherein said networks are capable of being reversibly disrupted by application of a shear force and of being re-formed upon discontinuation of said force.

65. A composition according to claim 62 wherein said alkali-swellable polymer incorporates associative copolymers or functional surfactants containing hydrophobic moieties, said moieties reversibly associating with one another to form networks in aqueous solution, wherein said networks are capable of being reversibly disrupted by application of a shear force and of being re-formed upon discontinuation of said force.

66. A composition according to claim 62 wherein said alkali-swellable thickener incorporates associative copolymers or functional surfactants and is ampholytic.

67. A composition according to claim 66, wherein at least one of said associative copolymers is a polymeric reaction product of one or more monomers selected from the group consisting of nonionic, anionic and cationic monomers, wherein at least one of said nonionic monomers is selected from the group consisting of monomers of styrene, C₁ to C₂₀ acrylates, C₁ to C₂₀ methacrylates, vinyl acetate acrylonitrile, methylacrylonitrile, isopropenyl -hydroxypropyl isocyanate, alpha, alpha-dimethyl-m-isopropenyl benzyl isocyanate, vinyl sulphonate, styrene phosphonate, acrylamide, methacrylamide, β-hydroxyethyl acrylate, and allyl alcohol and allyl chloride, hydroxypropyl methacrylate, hydroxyethyl acrylate, hydroxylethyl methacrylate, 2,3 glycididyl methacrylate, lauryl acrylate, butanediol monoacrylate, 2-hydroxypropyl acrylate, 2-hydroxyethyl acrylate, isobutyl acrylate, 2-ethylhexyl acrylate, tertiarybutyl methacrylates, tertiarybutyl acrylate, decyl methacrylate isomers, lauryl methacrylate, stearyl methacrylates, and any di -or tri-acrylate or methacrylate functional monomers, ethylene, vinyl acetate, C₃ to C₂₀ alpha olefin, 3-butadiene, isoprene; wherein at least one of said anionic monomers is selected from the group consisting of acrylic acid, methacrylic acid, β-carboxyethyl acrylate, maleic acid, maleic anhydride, fumaric acid, fumaric anhydride, itaconic acid, styrene sulfonic acid, 2-acrylamido-2-methylpropane sulfonic acid, styrene sulfonic acid, vinyl sulfoacid, sulfoalkylacrylates, sulfoalkyl acrylamides, allyl sulfonic acid, methallyl sulfonic acid, allyl glycidyl ether sulfonate, vinyl acetic acid, allylacetic acid, 4-methyl-4-pentenoic acid, α-haloacrylic acid, β-hydroxyethyl acrylate, β-carboxyethyl acrylate and water soluble salts thereof; and wherein at least one of said cationic monomers is selected from the group consisting of dimethyl or diethyl aminoethylmethacrylate or dimethyl diethyl aminopropyl(meth)acrylamide, N,N-dimethylamino propylacrylamide, N,N-dimethylamino propylacrylamide, methyl chloride quat, diacetone acrylamide, hydroxy ethyl acrylamide, N,N-dimethyl acrylamide, dimethylaminoethyl acrylate, N-isopropylacrylamide, N-alkylacrylamides, N,N-diethyl acrylamide, dimethyl acrylamide, dimethylamino propylacrylamide.

68. A composition according to claim 62, wherein said cationic polymer comprises a polymeric reaction product of one or more monomers selected from the group consisting of dimethyl or diethyl aminoethylmethacrylate or dimethyl diethyl aminopropyl(meth)acrylamide, N,N-dimethylamino propylacrylamide, N,N-dimethylamino propylacrylamide, methyl chloride quat, diacetone acrylamide, hydroxy ethyl acrylamide, N,N-dimethyl acrylamide, dimethylaminoethyl acrylate, N-isopropylacrylamide, N-alkylacrylamides, N,N-diethyl acrylamide, dimethyl acrylamide, dimethylamino propylacrylamide.

69. A composition according to claim 62, wherein said cationic polymer comprises a polymeric reaction product of one or more monomers selected from the group consisting of ethyleneimine, quaternized dimethylaminoethyl methacrylates, N,N-dimethylaminopropyl methacrylamide, methacryloxy ethyl dimethyl amine, methacrylamido propyl dimethyl amine, acryloxy ethyl dimethyl amine, acrylamido methyl propyl dimethyl amine, dimethyl diallyl ammonium chloride, diethyl diallyl ammonium chloride, dimethyl allyloxyethyl amine; the water soluble salts, acid salts, methylsulfate derivatives and methyl chloride derivatives thereof; and mixtures thereof.

70. A composition according to claim 13 wherein a emulsion polymerized oil in water or water in oil polymer produced with at least one of said monomers is stabilized in its emulsion form or dried emulsion form with surfactants, soaps, or detergents prepared as synthetics or derivatized natural substances comprising sulfo-succinates, mono or diesters, ether sulfonates, sulfonated oils, ether carbonates, ether phosphates, stearates and other fatty acid esters with or without ethoxylation, propylation, and butyoxalation, alkyl sulfates of C₁ to C₂₄, functional ethoxylates, alkoxylates, phenol, diphenol, alkyl C₁ to C₂₄ produced using ethyleneoxide, propylene oxide or butylene oxide or mixtures and derivatives thereof, methacrylic anhydride, isopropenyl styrene-isocyanate, alpha, alpha-dimethyl-m-isopropenyl benzyl isocyanate, maleic anhydride, itaconic anhydride, fumaric anhydride or their corresponding acids to form esters, glucosides, disulfonates, betaines, quaternary ammonium salts, alkyl sulfates, olefin sulfonates, isethionates, hydrotropes, alkyl phenols with ethoxylation, propoxylation, and butoxylation, amine oxides and their derivatives, block copolymers, sorbitan fatty esters with or without ethoxylation, propyoxylation and butoxylation, styrene sulfonate, xylenesulfonate or naphthalene sulfonates and their derivatives.
